(19) United States
(12) Patent Application Publication
(10) Pub. No.: US 2008/0114142 A1
(43) Pub. Date: May 15, 2008

(54) Ethylene-Propylene Copolymer Compositions and Methods of Making and Using Same

(75) Inventors: Jennifer L. Hicks, Bartlesville, OK (US); William R. Bridendolph, Ochelata, OK (US); Donald E. Allen, Bartlesville, OK (US); Kenichiro Yada, Chiba Pref. (JP); Amelia L. Gonzalez, Houston, TX (US)

Correspondence Address: CHEVRON PHILLIPS CHEMICAL COMPANY, 5601 Granite Parkway, Suite 750, PLANO, TX, 75024, US

(73) Assignee: PHILLIPS SUMIKA POLYPROPYLENE COMPANY, The Woodlands, TX (US)

(21) Appl. No.: 11/936,908

(22) Filed: Nov. 8, 2007

Related U.S. Application Data
(60) Provisional application No. 60/865,341, filed on Nov. 10, 2006.

(51) Int. Cl. C08F 10/06

(52) U.S. Cl. 526/348

(57) ABSTRACT

An ethylene-propylene copolymer having a cold xylene solubles weight percent greater than twice the magnitude of the ethylene content wherein the ethylene content is measured by C13-NMR and having less than about 30% of the cold xylene solubles fraction having a log weight average chain length of less than about 1000 wherein the weight average chain length is measured by gel permeation chromatography. A method of producing a copolymer comprising contacting comonomers with a catalyst system in a reaction zone under conditions suitable for the formation of a copolymer wherein the catalyst system comprises at least two external donors and wherein the copolymer has a cold xylene solubles weight percent greater than twice the magnitude of the ethylene content wherein the ethylene content is measure by C13-NMR and having less than about 30% of the cold xylene solubles fraction having a log weight average chain length of less than about 1000 wherein the weight average chain length is measured by gel permeation chromatography.

### CROSS-REFERENCE TO RELATED APPLICATIONS

This application claims priority to U.S. Provisional Application No. 60/865,341, filed on Nov. 10, 2006, and entitled “Ethylene-Propylene Copolymer Compositions and Methods of Using Same,” which is incorporated by reference herein in its entirety.

### TECHNICAL FIELD

The present disclosure relates to polymer compositions and products made from same, more specifically to ethylene-propylene copolymer compositions for the manufacture of blowmolded bottles, film, sheet, thermoformed packaging and injection molded products.

### BACKGROUND

Thermoplastic materials are widely used for the fabrication of a variety of consumer products. The physical properties of such materials determine their utility for a particular application. For example, thermoplastics used in the manufacture of food containers must display a desirable combination of strength and optical properties so as to behave well during the manufacturing process and be fabricated into a product that is aesthetically pleasing. Thus there is an ongoing need to develop polymeric compositions having a user desired combination of physical properties such as improved mechanical and/or optical properties.

### SUMMARY

Disclosed herein is an ethylene-propylene copolymer having a cold xylene solubles weight percent greater than twice the magnitude of the ethylene content wherein the ethylene content is measured by C13-NMR and having less than about 30% of the cold xylene solubles fraction having a log weight average chain length of less than about 1000 wherein the weight average chain length is measured by gel permeation chromatography.

Also disclosed herein is a method of producing a copolymer comprising contacting comonomers with a catalyst system in a reaction zone under conditions suitable for the formation of a copolymer wherein the catalyst system comprises at least two external donors and wherein the copolymer has a cold xylene solubles weight percent greater than twice the magnitude of the ethylene content wherein the ethylene content is measure by C13-NMR and having less than about 30% of the cold xylene solubles fraction having a log weight average chain length of less than about 1000 wherein the weight average chain length is measured by gel permeation chromatography.

Further disclosed herein is an ethylene-propylene copolymer having less than about 30% of the cold xylene solubles fraction having a weight average chain length of less than about 1000 wherein the weight average chain length is measured by gel permeation chromatography and having an elution ratio of a fractionation component in the temperature range of from about 88° C. to about 140° C. to a fractionation component in the temperature range of from about 88° C. to about 98° C. of greater than about 2.5:1 as determined by temperature rising elution fractionation.

### BRIEF DESCRIPTION OF THE DRAWINGS

FIG. 1 is a schematic of a polymerization reactor system.

### DETAILED DESCRIPTION

Disclosed herein are copolymer compositions and methods of using same. In an embodiment, the copolymer composition comprises an ethylene-propylene copolymer and may be prepared using a dual external donor catalyst system. Such compositions may display desirable properties such as an increased impact resistance and improved stiffness when compared to an otherwise similar copolymer composition prepared in the absence of a dual external donor catalyst system.

In an embodiment, the polymer composition comprises an ethylene-propylene random copolymer composition (EP-RCP). The EP-RCP may contain greater than about 0.1 wt. % ethylene, alternatively from about 0.1 wt. % to about 8.0 wt. %, alternatively from about 0.5 wt. % to about 7.0 wt. %, alternatively from about 1 wt. % to about 5 wt. %, alternatively from about 2 wt. % to about 4 wt. % wherein the ethylene content is measured by carbon-13 nuclear magnetic resonance (C13-NMR). In the detailed description that follows, unless otherwise specified, the ethylene content is determined by C13-NMR.

The EP-RCP may have a melt flow rate (MFR) of from about 0.1 g/10 min to about 200 g/10 min, alternatively from about 0.5 g/10 min to about 150.0 g/10 min, alternatively from about 0.7 g/10 min to about 100 g/10 min. The MFR is a measurement of the viscosity of a polymer through a defined orifice at a constant temperature and may be determined in accordance with ASTM D1238. The final viscosity may be adjusted through the use of hydrogen level in the reactor. Alternate methods of increasing or maintaining melt flow are known to one of ordinary skill in the art. For example, the melt flow may be increased through the use of chemical visbreaking agents such as peroxide added during the pellet finishing step.

In an embodiment the EP-RCPs of this disclosure have a melt strength of greater than about 7.5 seconds, alternatively greater than about 8.0 seconds. The melt strength refers to the strength of the plastic while in the molten state wherein the melt strength is measured by the hang time of a 150 gram parison at 210° C. immediately following extrusion from a 0.1 inch die gap.

In an embodiment, the EP-RCP has a percentage of cold xylene solubles (CXS) of greater than about 0.2 wt. %, alternatively from about 0.2 wt. % to about 16 wt. %, alternatively from about 1 wt. % to about 14 wt. %, alternatively from about 2 wt. % to about 10 wt. %, alternatively from about 4 wt. % to about 8 wt. %. Xylene solubles is an indication of the crystallinity of the polymeric material and may be measured by dissolving the polymer in hot xylene, (i.e. xylene a temperature of about 130° C. cooling the solution to about 20±0.5° C. and precipitating out the isotactic form. The CXS are the weight percent of the polymer that remained soluble in cold xylene (i.e., xylene at about 20±0.5° C.) and is an indicator of the amount of atactic material present in the polymer composition. The EP-RCPs of this disclosure have a CXS fraction weight percentage that is greater than about twice the magnitude of the ethylene content by weight (CXS>2*C2 wt. %), wherein the ethylene content is measured by C13-NMR. Further, the EP-RCPs of this disclosure have a CXS fraction comprised largely of high molecular weight components. This is evinced by a CXS fraction that has less than about 30 weight percent of the components having a log A_{w} less than about 3. The Aw is the weight average chain length of CXS fraction as measured by gel permeation chromatography (GPC). In other words, the majority of the components of the CXS fraction (i.e., greater than about 70%) have a chain length that is greater than 1000.

In an embodiment, the EP-RCP have a ethylene content ranging from about 0.1% to about 8 wt. %. In such embodiments, the EP-RCPs may have a melting temperature (Tm) of less than about 175° C., alternatively of from about 100° C. to about 175° C., alternatively of from about 110° C. to about 170° C., alternatively of from about 130° C. to about 160° C. The EP-RCP may be further characterized by a temperature melt of crystallization (T_{mc}) of from about 100° C. to about 135° C., alternatively from about 103° C. to about 130° C., alternatively from about 105° C. to about 125° C. Both the Tₘ and T_{mc} may be determined by one of ordinary skill in the art using commonly employed techniques such as differential scanning calorimetry (DSC).

In an embodiment, the EP-RCP has a specified intermolecular composition distribution that comprises a greater percentage of high temperature elution components when compared to an otherwise similar EP-RCP prepared in the absence of a dual external donor catalyst. High temperature elution components refer to high molecular components as well as a unique distribution of the ethylene comonomer and may indicate improved processability for the forming of articles. The specified intermolecular distribution may be determined using a variety of techniques as known to one of ordinary skill in the art such as temperature rising elution fractionation (TREF), differential scanning calorimetry (DSC), C13-NMR, and the like. In an embodiment, the specified intermolecular composition distribution is determined by TREF.

TREF is a two-step separation process in which a dissolved polymer sample is deposited onto a column filled with inert packing material by programmed cooling of the column. The sample is then redissolved into the flowing solvent or mobile phase by raising the temperature of the column slowly while flushing the column with solvent. The temperature at which the polymer fractions elute off the column is primarily a function of the ethylene comonomer within the sample, molecular weights, and the thermal history the polymer has experienced. In an embodiment, the EP-RCPs of this disclosure may be further characterized by a TREF elution ratio of greater than about 2.5:1 when comparing the fractionation component in the temperature range of from about 98 to about 140° C. to the fractionation component in the temperature range of from about 88 to about 98° C. Determination of the elution ratios using TREF may be carried out as known to one of ordinary skill in the art. For example, the elution ratio may be determined using an automatic TREF apparatus (e.g., CFC T-150A manufactured by Dia Instrument Co.) under conditions as described in the Examples.

The EP-RCPs of this disclosure may have an increased flexibility when compared to an otherwise similar EP-RCP prepared in the absence of a dual external donor catalyst system as evinced by a decrease in the flexural modulus. The flexural modulus may be defined as the ratio, within the elastic limit, of the applied stress on a test specimen in flexure, to the corresponding strain in the outermost fibers of the specimen. In an embodiment, the EP-RCPs of this disclosure have from about 0.1 wt. % to about 8.0 wt. % and a flexural modulus of equal to or less than about 300 kpsi, alternatively from about 15 kpsi to about 300 kpsi, alternatively from about 25 kpsi to about 275 kpsi, alternatively from about 80 kpsi to about 250 kpsi as determined in accordance with ASTM D790 using an injection molded test specimen tested at a rate of 13 mm/min. In an embodiment, the EP-RCP of this disclosure have a weight percent ethylene of from about 2.3 wt. % to about 2.5 wt. %. In such an embodiment, the flexural modulus may range from about 145 kpsi to about 155 kpsi as determined in accordance with ASTM D790 using an injection molded test specimen tested at a rate of 13 mm/min.

In an embodiment, the EP-RCPs of this disclosure have an improved Rockwell hardness when compared to an otherwise similar EP-RCP prepared in the absence of a dual external donor catalyst. The Rockwell Hardness test is a hardness measurement based on the net increase in depth of impression as a load is applied. The Rockwell hardness test method consists of indenting the test material with a diamond cone or hardened steel ball indenter. The indenter is forced into the test material under a preliminary minor load. When equilibrium has been reached, an indicating device, which follows the movements of the indenter and so responds to changes in depth of penetration of the indenter is set to a datum position. While the preliminary minor load is still applied an additional major load is applied with resulting increase in penetration. When equilibrium has again been reached, the additional major load is removed but the preliminary minor load is still maintained. Removal of the additional major load allows a partial recovery, so reducing the depth of penetration. The permanent increase in depth of penetration, resulting from the application and removal of the additional major load is used to calculate the Rockwell hardness number. Hardness numbers are unitless and are commonly given in the R, L, M, E and K scales. The higher the number in each of the scales means the harder the material.

In an embodiment, the EP-RCPs of this disclosure have an ethylene content in the range of from about 0.1 wt. % to about 8 wt. % and a Rockwell hardness, R-scale of equal to or less than about 100, alternatively from about 95 to about 65, alternatively from about 90 to about 70. In another embodiment, the EP-RCPs of this disclosure have an ethylene content in the range of from about 2.3 to about 2.5 wt. %. In such embodiments, the EP-RCP may have a Rockwell Hardness, R-scale of from about 90 to about 80. The EP-RCPs of this disclosure may display a lower Rockwell Hardness R-scale value at a lower ethylene content when compared to an otherwise similar EP-RCP prepared in the absence of a dual external donor catalyst. The improved manufacturing efficiency observed with materials prepared using the EP-RCPs of this disclosure may be attributable at least in part to the lower Rockwell hardness value for the EP-RCPs of this disclosure. The lower Rockwell hardness values suggest the EP-RCPs of this disclosure are softer materials which may reduce downtime associated with knifewear and related maintenance issues.

The EP-RCPs of this disclosure may be further characterized by an impact strength equal to or greater than an otherwise similar EP-RCP prepared in the absence of a dual external donor catalyst system as evinced by the values obtained for the Notched Izod impact, the bottle drop impact resistance.

In an embodiment, the EP-RCPs of this disclosure have an ethylene content in the range of from about 0.1 wt. % to about 8 wt. % and a Notched Izod impact strength of less than No Break, alternatively a Notched Izod impact strength of from about 0.2 ft*lb_{f}/in to No Break, alternatively from about 0.3 ft*lb_{f}/in to No Break, alternatively from about 0.4 ft*lb_{f}/in to No Break. In an alternative embodiment, the EP-RCPs of this disclosure have a ethylene content ranging from about 2.3 wt. % to about 2.5 wt. % and have a Notched Izod impact strength of greater than about 6 ft*lb_{f}/in. The Notched Izod impact strength refers to the energy per unit thickness required to break a test specimen under flexural impact and may be determined in accordance with ASTM D256. The notched Izod impact may be measured using a test specimen that is held as a vertical cantilevered beam and is impacted by a swinging pendulum. The energy lost by the pendulum is equated with the energy absorbed by the test specimen.

In an embodiment, the EP-RCPs of this disclosure have an ethylene content of from about 0.1 wt. % to about 8 wt. % and a bottle drop impact strength of greater than about 0.5 feet, alternatively from about 0.5 feet to about 12 feet, alternatively from about 1 foot to about 9 feet, alternatively from about 1.5 feet to about 8 feet. In an alternative embodiment, the EP-RCPs of this disclosure have a ethylene content ranging from about 2.3 wt. % to about 2.5 wt. % and a bottle drop impact strength of greater than about 9 feet. The bottled drop may be determined in accordance with ASTM D2463 using a test specimen bottle having a thread diameter of 1.462 inches, a thread height of 0.375 inches, a small diameter of 6.000 inches, a large diameter of 6.250 inches, a wall thickness of 0.030 inches, an empty bottle weight of 150 g and a filled bottle weight of 4000 g.

The EP-RCPs of this disclosure may have improved optical properties when compared to an otherwise similar EP-RCP prepared in the absence of a dual external donor catalyst system. Alternatively, the EP-RCPs of this disclosure may have optical properties similar to that of an otherwise similar EP-RCP prepared in the absence of a dual external donor catalyst system. Specifically, the EP-RCPs of this disclosure may have an improved haze and clarity when compared to an otherwise similar EP-RCP prepared in the absence of a dual external donor catalyst system. Herein haze is defined as the percent of transmitted light that is scattered more than 2.5° from the direction of the incident beam while clarity refers to the cloudiness of specimen prepared from the polymeric composition both of which may be determined in accordance with ASTM D1003. The internal haze is related to the crystallinity of the polymer.

Without wishing to be limited by theory, the ethylene content influences the haze of these materials with lower haze values returned when higher levels of ethylene comonomer are used during polymer manufacturing. For the EP-RCPs of this disclosure, the haze values obtained are similar to the values obtained with an EP-RCP having a higher ethylene level prepared in the absence of a dual external donor catalyst system.

In an embodiment, the EP-RCPs of this disclosure have a ethylene content of from about 0.1 wt. % to about 8 wt. % and the haze is less than about 35%, alternatively, the haze is from about 35% to about 1%, alternatively from about 30% to about 2%, alternatively from about 25% to about 3%. Such materials may be further characterized by a clarity of from about 85% to about 99%, alternatively the clarity from about 87% to about 99%, alternatively the clarity from about 90% to about 98%.

In an alternative embodiment, the EP-RCPs of this disclosure have an ethylene content ranging from about 2.3 wt. % to about 2.5 wt. % and a haze of less than about 10% and a clarity of greater than about 95%.

In an embodiment, both the internal haze and clarity may be measured on a wall of a specimen bottle prepared from an EP-RCP of this disclosure having an ethylene content ranging from about 2.3 wt. % to about 2.5 wt. %. The specimen bottle may have a thread diameter of 1.462 inches, a thread height of 0.375 inches, a small diameter of 6.000 inches, a large diameter of 6.250 inches, a wall thickness of 0.030 inches, an empty bottle weight of 150 g and a filled bottle weight of 4000 g. In such an embodiment, the haze may be less than about 19% and the clarity may be greater than about 98%.

The EP-RCPs of this disclosure may have improved thermal properties when compared to an otherwise similar EP-RCP prepared in the absence of a dual external donor catalyst system.

In an embodiment, the EP-RCPs of this disclosure have a ethylene content of from about 0.1 wt. % to about 8 wt. % and the seal initiation temperature is less than about 155° C. Alternatively, the seal initiation temperature is from about 110° C. to about 155° C., alternatively from about 115° to about 145° C., alternatively from about 120° C. to about 135° C. These materials may be further characterized by a hot tack opening force of greater than about 0.1 lb. Alternatively, the hot tack opening force is from about 0.1 to about 5 lbs, alternatively from about 0.3 to about 4 lbs, alternatively from about 0.4 to about 3 lbs.

In an alternative embodiment, the EP-RCPs of this disclosure have an ethylene content ranging from about 2.3 wt. % to about 2.5 wt. %, a seal initiation temperature of about 126° C. and a hot tack opening force of about 0.5 lb. The EP-RCPs may be further characterized by about a 30% increase in the hot tack opening force when compared to an otherwise similar EP-RCP prepared in the absence of a dual external donor catalyst system.

In an embodiment, the EP-RCP may contain additives as deemed necessary to impart desired properties. Such additives are known to one of ordinary skill in the art and include without limitation antioxidants, process stabilizers, nucleators, slip agents, free radical scavengers, processing aids, clarifying agents, antiblocking agents, antistatic agents, UV stabilizers, impact modifiers, acid scavengers, lubricants, long-term heat stabilizers, peroxides, mineral and organic-fillers, glass-fillers, metal deactivators and the like. These additives may be included singularly or in combination. Effective amounts of these additives and methods for their inclusion in the polymeric composition are known to one of ordinary skill in the art.

In an embodiment, the EP-RCPs of this disclosure may be fashioned by a plastics shaping process into intermediate or end-use articles. The EP-RCPs of this disclosure may be used to form intermediate and end-use articles that display a reduced shrinkage when compared to articles formed from an otherwise similar EP-RCP prepared in the absence of a dual external donor catalyst system. Examples of such articles include without limitation sheets, films, bottles, food storage containers, blister packs and the like. Other intermediate and end-use articles would be apparent to one of ordinary skill in the art. Examples of plastic shaping processes include without limitation blow molding, film extrusion, sheet extrusion, thermoforming and injection molding, injection blow molding and injection stretch blow molding.

The EP-RCPs of this disclosure may display improved processability and when utilized in a manufacturing or production process may function to improve the efficiency of said process when compared to a process employing an otherwise similar EP-RCP prepared in the absence of a dual external donor catalyst system. In an embodiment, the EP-RCPs of this disclosure may be used to manufacture film, sheet, injection molded, blow molded, thermoformed, or pipe products. For example, the EP-RCPs of this disclosure may improve the efficiency of the manufacturing process by showing an improved extruder output. Without wishing to be limited by theory, the improved processability of the EP-RCPs of this disclosure may allow for their more facile movement through an extruder thus decreasing the polymer production time and increasing the overall manufacturing efficiency. Furthermore, the use of the EP-RCPs of this disclosure which display an increased flexibility may result in a reduced incidence of knifewear for the cutting and trimming of the blowmolded articles, formed sheets or films when compared to films or sheets or bottles formed from an otherwise similar EP-RCP prepared in the absence of a dual external donor catalyst system. The reduced incidence of knifewear would require less production downtime for the replacement of worn equipment and thus an overall improved manufacturing efficiency.

The EP-RCPs of this disclosure when processed by injection stretch blow molding exhibit a reduced variation in the wall thickness of an article manufactured from these materials (e.g., a bottle). Without wishing to be limited by theory, the use of dual external donor catalyst system affords the production of a copolymer having a number physical properties that are typically observed in a copolymer having a higher ethylene content. The ability to achieve these properties at a lower ethylene content provides among other benefits, a decrease in the tackiness of the polymer pellet as well as the fabricated article resulting in a lower coefficient of friction which is manifested as improved pellet flowability and improved part conveyability. In an embodiment, an article (e.g., bottle) fabricated from the EP-RCPs of this disclosure have a positive or negative variation in wall thickness of less than about 0.003 inches, alternatively equal to or less than about 0.002 inches, alternatively equal to or less than about 0.001 inches.

In an embodiment, the EP-RCPs of this disclosure are prepared using a dual external donor catalyst system. The catalyst system may consist of (A) a solid catalyst component comprising magnesium, titanium, halogen and an internal electron donor component, (B) an organoaluminum compound, and (C) at least one external electron donor component comprising at least two electron donor compounds.

The solid catalyst component (A) comprising magnesium, titanium, halogen, and an internal electron donor component are generally referred to as titanium-magnesium complex catalysts and may be obtained by contacting the magnesium compounds, titanium compounds and internal electron donor component of the types to be described in more detail later herein simultaneously.

For example, titanium compounds useful for the synthesis of solid catalyst component (A), include without limitation titanium compounds represented by the following general formula:

Ti(OR¹)ₐX₍₄₋ₐ₎

wherein R¹ represents a hydrocarbon group having 1 to 20 carbon atoms, X represents a halogen atom, and a represents a value that is greater than or equal to 0 and less than or equal to 4 (0≦a≦4). Examples of such compounds include without limitation, titanium tetrahalide compounds such as titanium tetrachloride, titanium tetrabromide, titanium tetraiodide and the like, alkoxytitanium trihalide compounds such as methoxytitanium trichloride, ethoxytitanium trichloride, butoxytitanium trichloride, phenoxytitanium trichloride, ethoxytitanium tribromide and the like, dialkoxytitanium dihalide compounds such as dimethoxytitanium dichloride, diethoxytitanium dichloride, dibutoxytitanium dichloride, diphenoxytitanium dichloride, diethoxytitanium dibromide and the like, trialkoxytitanium halide compounds such as trimethoxytitanium chloride, triethoxytitanium chloride, tributoxytitanium chloride, triphenoxytitanium chloride, triethoxytitanium bromide and the like, and tetraalkoxytitanium compounds such as tetramethoxytitanium, tetraethoxytitanium, tetrabutoxytitanium, tetraphenoxytitanium and the like. These titanium compounds may be used either in the form of a single compound or in the form of a mixture of two or more compounds. Further, if desired, these titanium compounds may be used after dilution with a hydrocarbon, halogenated hydrocarbon compound, or the like as known to one of ordinary skill in the art.

The magnesium compound used in the synthesis of the solid catalyst component (A), may comprise reductive magnesium compounds having a magnesium-carbon bond or a magnesium-hydrogen bond. Alternatively, non-reductive magnesium compounds may be employed. Specific examples of reductive magnesium compounds suitable for use in this disclosure include without limitation dimethylmagnesium, diethylmagnesium, dipropylmagnesium, dibutylmagnesium, dihexylmagnesium, butylethylmagnesium, ethylmagnesium chloride, butylmagnesium chloride, hexylmagnesium chloride, butylethoxymagnesium, butylmagnesium hydride, combinations thereof, or derivatives thereof. If desired, these reductive magnesium compounds may be used in the form of a complex compound with an organoaluminum compound. Specific examples of non-reductive magnesium compounds suitable for use in this disclosure include without limitation magnesium dihalide compounds such as magnesium dichloride, magnesium dibromide, magnesium diiodide, derivatives thereof, or combinations thereof; alkoxymagnesium halide compounds such as methoxymagnesium chloride, ethoxymagnesium chloride, butoxymagnesium chloride, isopropoxymagnesium chloride, phenoxymagnesium chloride derivatives thereof, or combinations thereof; dialkoxymagnesium compounds such as diethoxymagnesium, dibutoxymagnesium, diisopropoxymagnesium, diphenoxymagnesium derivatives thereof, or combinations thereof; and magnesium carboxylates such as magnesium laurate, magnesium stearate derivatives thereof, or combinations thereof. If desired, said non-reductive magnesium compounds may be a compound synthesized from a reductive magnesium compound according to any method known to one of ordinary skill in the art. The magnesium component of the solid catalyst component (A) may be synthesized prior to or at the time of preparation of the solid catalyst component (A).

The electron donor compound used in the synthesis of solid catalyst component (A) may comprise for example and without limitation oxygen-containing electron donor compounds such as alcohols, phenols, ketones, aldehydes, carboxylic acids, esters of organic and inorganic acids, ethers, acid amides, acid anhydrides, derivatives thereof, or combinations thereof; nitrogen-containing electron donor compounds such as ammonia, amines, nitriles, isocyanates, derivatives thereof, or combinations thereof.

In an embodiment, the electron donor compounds, comprise esters and/or ethers of organic and inorganic acids such as the esters of mono- and poly-carboxylic acids. Examples of such esters of mono and poly-carboxylic acids include without limitation esters of aliphatic carboxylic acids, esters of olefinic carboxylic acids, esters of alicyclic carboxylic acids, and esters of aromatic carboxylic acids. Specific examples thereof include without limitation methyl acetate, ethyl acetate, phenyl acetate, methyl propionate, ethyl propionate, ethyl butyrate, ethyl valerate, methyl acrylate, ethyl acrylate, methyl methacrylate, ethyl benzoate, butyl benzoate, methyl toluate, ethyl toluate, ethyl anisate, diethyl succinate, dibutyl succinate, diethyl malonate, dibutyl malonate, dimethyl maleate, dibutyl maleate, diethyl itaconate, dibutyl itaconate, monoethyl phthalate, dimethyl phthalate, methyl ethyl phthalate, diethyl phthalate, di-n-propyl phthalate, diisopropyl phthalate, di-n-butyl phthalate, diisobutyl phthalate, di-n-octyl phthalate, diphenyl phthalate; derivatives thereof, or combinations thereof.

In an embodiment, the electron donor compounds, comprise esters and/or ethers of silicon compounds represented by the following general formula:

R²ₙSi(OR³)₄₋ₙ

wherein R² represents a hydrocarbon group having 1 to 20 carbon atoms or a hydrogen atom, R³ represents a hydrocarbon group having 1 to 20 carbon atoms, and n represents a number that is less than or equal to 4 and greater than or equal to zero (0≦n≦4). Specific examples of said silicon compounds include tetramethoxysilane, tetraethoxysilane, tetrabutoxysilane, tetraphenoxysilane, methyltrimethoxysilane, ethyltrimethoxysilane, butyltrimethoxysilane, isobutyltrimethoxysilane, t-butyltrimethoxysilane, isopropyltrimethoxysilane, cyclohexyltrimethoxysilane, phenyltrimethoxysilane, vinyltrimethoxysilane, dimethyldimethoxysilane, diethyldimethoxysilane, dipropyldimethoxysilane, propylmethyldimethoxysilane, diisopropyldimethoxysilane, dibutyldimethoxysilane, diisobutyldimethoxysilane, di-t-butyldimethoxysilane, butylmethyldimethoxysilane, butylethyldimethoxysilane, t-butylmethyldimethoxysilane, hexylmethyldimethoxysilane, hexylethyldimethoxysilane, dodecylmethyldimethoxysilane, dicyclopentyldimethoxysilane, cyclopentylmethyldimethoxysilane, cyclopentylethyldimethoxysilane, cyclopentylisopropyldimethoxysilane, cyclopentylisobutyl-dimethoxysilane, cyclopentyl-t-butyldimethoxysilane, dicyclohexyldimethoxysilane, cyclohexylmethyldimethoxysilane, cyclohexylethyldiethoxysilane, cyclohexylisopropyldimethoxy-silane, cyclohexylisobutyldimethoxysilane, cyclohexyl-t-butyldimethoxysilane, diphenyldimethoxysilane, phenylmethyldimethoxysilane, vinylmethyldimethoxysilane, methyltriethoxysilane, ethyltriethoxysilane, butyltriethoxysilane, isobutyltriethoxysilane, t-butyltriethoxysilane, isopropyltriethoxysilane, cyclohexyltriethoxysilane, phenyltriethoxysilane, vinyltriethoxysilane, dimethyldiethoxysilane, diethyldiethoxysilane, dipropyldiethoxysilane, propylmethyldiethoxysilane, diisopropyldiethoxysilane, dibutyldiethoxysilane, diisobutyldiethoxysilane, di-t-butyldiethoxysilane, butylmethyldiethoxysilane, butylethyldiethoxysilane, t-butylmethyldiethoxysilane, hexylmethyldiethoxysilane, hexylethyldiethoxysilane, dodecylmethyldiethoxysilane, dicyclopentyldiethoxysilane, dicyclohexyldiethoxysilane, cyclohexylmethyldiethoxysilane, cyclohexylethyldiethoxysilane, diphenyldiethoxysilane, phenylmethyldiethoxysilane, vinylmethyldiethoxysilane, ethyltriisopropoxysilane, vinyltributoxysilane, phenyltri-t-butoxysilane, 2-norbornanetrimethoxysilane, 2-norbornanetriethoxysilane, 2-norbornanemethyldimethoxysilane, trimethylphenoxysilane, methyltriallyloxysilane, derivatives thereof, or combinations thereof.

In an embodiment, the electron donor compounds comprise dialkyl ether compounds such as those represented by the following general formula:

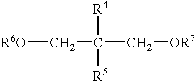

wherein R⁴, R⁵, R⁶, and R⁷ each represents linear or branched alkyl groups having 1 to 20 carbon atoms, acyclic groups, aryl groups, alkylaryl groups, arylalkyl groups, or combinations thereof provided that R⁴, R⁵, R⁶, and R⁷ may be similar with or different from one another and each of R⁴ and R⁵ may also be a hydrogen atom. Specific examples of ether compounds that may be suitable for use as the electron donor compound include without limitation diethyl ether, dipropyl ether, diisopropyl ether, dibutyl ether, diamyl ether, diisoamyl ether, dineopentyl ether, dihexyl ether, dioctyl ether, methyl butyl ether, methyl isoamyl ether, ethyl isobutyl ether, 2,2-diisobutyl-1,3-dimethoxypropane, 2-isopropyl-2-isopentyl-1,3-dimethoxypropane, 2,2-bis(cyclohexylmethyl)-1,3-dimethoxypropane, 2-isopropyl-2-3,7-dimethyloctyl-1,3-dimethoxypropane, 2,2-diisopropyl-1,3-dimethoxypropane, 2-isopropyl-2-cyclohexylmethyl-1,3-dimethoxypropane, 2,2-dicyclohexyl-1,3-dimethoxypropane, 2-isopropyl-2-isobutyl-1,3-dimethoxypropane, 2,2-diisopropyl-1,3-dimethoxypropane, 2,2-dipropyl-1,3-dimethoxypropane, 2-isopropyl-2-cyclohexyl-1,3-dimethoxypropane, 2-isopropyl-2-cyclopentyl-1,3-dimethoxypropane, 2,2-dicyclopentyl-1,3-dimethoxypropane, 2-heptyl-2-pentyl-1,3-dimethoxypropane; derivatives thereof; or combinations thereof. In an embodiment, the electron donor compound comprises an ester of the type described herein.

Solid catalyst components (A) of the type described herein may be prepared using methods known to one of ordinary skill in the art. For examples, such methods are disclosed in the following patents: JP-B-52-39431, JP-B-52-36786, JP-A-54-94590, JP-A-55-36203, JP-A-56-41206, JP-A-57-63310, JP-A-57-59916, JP-A-58-83006, JP-A-61-218606, JP-A-1-319508, JP-A-3-706, each of which is incorporated by reference herein in its entirety.

Methods of preparing the solid catalyst component can be exemplified by the following: (1) a method of reacting a liquid magnesium compound or a complex compound consisting of a magnesium compound and an electron donor compound with a depositing agent and thereafter treating the reaction product with a titanium compound or a combination of titanium compound and electron donor compound;

(2) a method of treating a solid magnesium compound or a complex compound consisting of a solid magnesium compound and an electron donor compound with a titanium compound or a combination of titanium compound and electron donor compound;
(3) a method of reacting a liquid magnesium compound with a liquid titanium compound in the presence of an electron donor compound and thereby depositing a solid titanium composite compound;
(4) a method of further treating the reaction product obtained by methods (1), (2) or (3) with a titanium compound or a combination of electron donor compound and titanium compound;
(5) a method of reducing an alkoxytitanium compound with an organomagnesium compound such as Grignard reagent or the like in the presence of an organic silicon compound having a Si—O bond to obtain a solid product, followed by treating said solid product with an ester compound, an ether compound and titanium tetrachloride;
(6) a method of mutually contacting and reacting a metal oxide, dihydrocarbylmagnesium and a halogen-containing alcohol to obtain a product, followed by treating or not treating the product with a halogenating agent and then contacting the product with an electron donor compound and a titanium compound;
(7) a method of treating or not treating a magnesium compound such as a magnesium salt of organic acid, alkoxymagnesium or the like with a halogenating agent followed by contacting the magnesium compound with an electron donor compound and a titanium compound; and
(8) a method of treating the compound obtained in methods (1) to (7) with any one of halogen, halogen compound and aromatic hydrocarbon.

In an embodiment, a solid catalyst component (A) of the type described herein is synthesized as described in method (1), (2), (3), (4), or (5). Alternatively, a solid catalyst component of the type described herein is synthesized as described in method (5).

Although the solid catalyst component (A) can be used as a catalyst in the absence of other components, it may also be used after impregnation into a porous material such as inorganic oxides, organic polymers and the like. Examples of porous inorganic oxide suitable for use in this disclosure include without limitation, SiO₂, Al₂O₃, MgO, TiO₂, ZrO₂, SiO₂—Al₂O₃ composite oxide, MgO—Al₂O₃ composite oxide, MgO—SiO₂—Al₂O₃ composite oxide, derivatives thereof, or combinations thereof. Examples of porous organic polymers suitable for use in this disclosure include without limitation, polymeric compositions comprising polystyrene, polyacrylic ester, polyacrylonitrile, polyvinyl chloride, polyolefins, and combinations thereof. Specific examples of porous organic polymers include without limitation polystyrene, styrene-divinyl-benzene copolymer, styrene-n,n′-alkylenedimethacrylamide copolymer, styrene-ethylene glycol dimethyl methacrylate copolymer, polyethyl acrylate, methyl acrylate-divinyl-benzene copolymer, ethyl acrylate-divinylbenzene copolymer, polymethyl methacrylate, methyl methacrylatedivinylbenzene copolymer, polyethyleneglycol dimethyl methacrylate, polyacrylonitrile, acrylonitrile-divinyl-benzene copolymer, polyvinyl chloride, polyvinylpyrrolidine, polyvinylpyridine, ethylvinylbenzenedivinylbenzene copolymer, polyethylene, ethylene-methyl acrylate copolymer, and polypropylene. In an embodiment, the porous organic materials comprise, SiO₂, Al₂O₃ styrene-divinylbenzene copolymer, or combinations thereof.

The organoaluminum compounds which can be used as component (B) of the present disclosure are those having at least one Al-carbon bond in one molecule. Typical organoaluminum compounds of the present disclosure are represented by the following general formulas:

R⁸ₘAlY₃₋ₘ

R⁹R¹⁰Al—O—AlR¹¹R¹²

wherein R⁸, R⁹, R¹⁰, R¹¹, and R¹² each represents a hydrocarbon group having 1 to 8 carbon atoms, provided that R⁸, R⁹, R¹⁰, R¹¹, and R¹² may be similar with or different from one another, Y represents a halogen, a hydrogen or an alkoxy group, and m represents a number that is greater than or equal to 2 but less than or equal to 3 (2≦m≦3). Specific examples of such organoaluminum compound include trialkylaluminum compounds such as triethylaluminum, triisobutylaluminum, trihexylaluminum and the like, dialkylaluminum hydrides such as diethylaluminum hydride, diisobutylaluminum hydride and the like, mixtures of a trialkylaluminum and a dialkylaluminum halide such as mixture of triethylaluminum and diethylaluminum chloride, and alkylalumoxanes such as tetraethyldialumoxane, tetrabutyldialumoxane and the like. In an embodiment, the organoaluminum compounds, comprise trialkylaluminum compounds, mixtures of a trialkylaluminum and a dialkylaluminum halides, and alkylalumoxanes. Alternatively, the organoaluminum compounds comprise triethylaluminum, triisobutylaluminum, mixtures of triethylaluminum and diethylaluminum chloride, and tetraethyldialumoxane.

In an embodiment, the catalyst comprises an electron donor component (C) comprising at least two electron donor compounds designated electron donor compound alpha (α) and electron donor compound beta (β), also referred to as a dual electron donor component (C).

Thus, the 105° C. xylene-soluble fraction of a homopolypropylene obtained by carrying out a polymerization using electron donative compound (α) together with the above-mentioned solid catalyst component (A) and organoaluminum compound (B) shows a pentad stereoirregularity index (mmrr/mmmm) satisfying the following condition:

0≦mmrr/mmmm≦0.0068,

alternatively, the following condition:

0.0004≦mmrr/mmmm≦0.0068, and

the 105° C. xylene-insoluble fraction of a homopolypropylene obtained by carrying out polymerization using electron donative compound (β) together with the above-mentioned solid catalyst component (A) and organo-aluminum compound (B) shows a pentad stereoirregularity index satisfying the following condition:

0.0068≦mmrr/mmmm≦0.0320,

alternatively, the following condition:

0.0068≦mmrr/mmmm≦0.0200,

and further alternatively the following condition:

0.0072≦mmrr/mmmm≦0.0140.

As used herein, the term “105° C. xylene-insoluble fraction” means the weight (%) of a fraction measured according to the method of Kakugo et al. [Macromolecules, 21, 314-319 (1988)], namely by dissolving a polypropylene in xylene at 130° C., throwing sea sand into the resulting solution, cooling the mixture to 20° C. again heating the mixture, and measuring the weight (%) of a fraction which is not extracted at 105° C. and extracted in the temperature range exceeding 105° C. and not exceeding 130° C. On the other hand, the term “pentad stereoirregularity index” means peak intensity ratio of the pentad fraction mmrr (the peak appears at about 21.01 ppm when TMS standard is used) to the pentad fraction mmmm (the peak appears at about 21.78 ppm when TMS standard is used) in the pentamer unit of a polypropylene molecular chain as measured at 135° C. at 270 MHz, on a solution of polymer in o-dichlorobenzene containing 10% by weight of C₆ D₆ (concentration of polymer=150 mg/³ ml) by means of C13-NMR (EX-270, manufactured by Nippon Denshi K. K.) according to the paper of A. Zambelli et al. [Macromolecules, 13, 687-689 (1975)]. The electron donor compounds (α and β) used for preparation of the electron donor catalyst component (C) may comprise the same and/or different electron donor compounds than those used in the preparation of solid catalyst component (A), described previously herein.

In an embodiment, electron donor compound (α) and electron donor compound (β) are independently selected from the organic silicon compounds represented by the following general formula:

R²ₙ(SiOR³)₄₋ₙ

wherein R² represents a hydrocarbon group having 1 to 20 carbon atoms or a hydrogen atom, R³ represents a hydrocarbon group having 1 to 20 carbon atoms, and n represents a number greater than or equal to 0 and less than or equal to 4 (0≦n≦4). Specific examples of such organic silicon compounds include without limitation: tetramethoxysilane, tetraethoxysilane, tetrabutoxysilane, tetraphenoxysilane, methyltrimethoxysilane, ethyltrimethoxysilane, butyltrimethoxysilane, isobutyltrimethoxysilane, t-butyltrimethoxysilane, isopropyltrimethoxysilane, cyclohexyltrimethoxysilane, phenyltrimethoxysilane, vinyltrimethoxysilane, dimethyldimethoxysilane, diethyldimethoxysilane, dipropyldimethoxysilane, propylmethyldimethoxysilane, diisopropyldimethoxysilane, dibutyldimethoxysilane, diisobutyldimethoxysilane, di-t-butyldimethoxysilane, butylmethyldimethoxysilane, butylethyldimethoxysilane, t-butylmethyldimethoxysilane, isobutylisopropyldimethoxysilane, t-butylisopropyldimethoxysilane, hexylmethyldimethoxysilane, hexylethyldimethoxysilane, dodecylmethyldimethoxysilane, dicyclopentyldimethoxysilane, cyclopentylmethyldimethoxysilane, cyclopentylethyldimethoxysilane, cyclopentylisopropyldimethoxysilane, cyclopentylisobutyl-dimethoxysilane, cyclopentyl-t-butyldimethoxysilane, dicyclohexyldimethoxysilane, cyclohexylmethyldimethoxysilane, cyclohexylethyldimethoxysilane, cyclohexylisopropyldimethoxy-silane, cyclohexylisobutyldimethoxysilane, cyclohexyl-t-butyldimethoxysilane, cyclohexylcyclopentyldimethoxysilane, cyclohexylphenyldimethoxysilane, diphenyldimethoxysilane, phenylmethyldimethoxysilane, phenylisopropyldimethoxysilane, phenylisobutyldimethoxysilane, phenyl-t-butyldimethoxysilane, phenylcyclopentyldimethoxysilane, vinylmethyldimethoxysilane, methyltriethoxysilane, ethyltriethoxysilane, butyltriethoxysilane, isobutyltriethoxysilane, t-butyltriethoxysilane, isopropyltriethoxysilane, cyclohexyltriethoxysilane, phenyltriethoxysilane, vinyltriethoxysilane, dimethyldiethoxysilane, diethyldiethoxysilane, dipropyldiethoxysilane, propylmethyldiethoxysilane, diisopropyldiethoxysilane, dibutyldiethoxysilane, diisobutyldiethoxysilane, di-t-butyldiethoxysilane, butylmethyldiethoxysilane, butylethyldiethoxysilane, t-butylmethyldiethoxysilane, hexylmethyldiethoxysilane, hexylethyldiethoxysilane, dodecylmethyldiethoxysilane, dicyclopentyldiethoxysilane, dicyclohexyldiethoxysilane, cyclohexylmethyldiethoxysilane, cyclohexylethyldiethoxysilane, diphenyldiethoxysilane, phenylmethyldiethoxysilane, vinylmethyldiethoxysilane, ethyltriisopropoxysilane, vinyltributoxysilane, phenyltri-t-butoxysilane, 2-norbornanetrimethoxysilane, 2-norbornanetriethoxysilane, 2-norbornanemethyldimethoxysilane, trimethylphenoxysilane, methyltriallyloxysilane, derivatives thereof, or combinations thereof.

In an embodiment, the electron donor component (C) comprises an electron donor compound (α) comprising organic silicon compounds represented by the following general formula:

R¹³R¹⁴Si(OR¹⁵)₂

In this general formula, R¹³ represents a C₃ to C₂₀ hydrocarbon group in which the carbon atom adjacent to Si is a secondary or tertiary carbon atom, and specific examples thereof include branched chain alkyl groups such as isopropyl, sec-butyl, t-butyl, t-amyl and the like, cycloalkyl groups such as cyclopentyl, cyclohexyl and the like, cycloalkenyl groups such as cyclopentenyl and the like, and aryl groups such as phenyl, tolyl and the like. In the general formula, R¹⁴ represents a C₁ to C₂₀ hydrocarbon group, of which specific examples include straight chain alkyl groups such as methyl, ethyl, propyl, butyl, pentyl and the like, branched chain alkyl groups such as isopropyl, sec-butyl, t-butyl, t-amyl and the like, cycloalkyl groups such as cyclopentyl, cyclohexyl and the like, cycloalkenyl groups such as cyclopentenyl and the like, and aryl groups such as phenyl, tolyl and the like. In the general formula, R¹⁵ represents a C₁ to C₂₀ hydrocarbon group, alternatively a C₁ to C₅ hydrocarbon group. Specific examples of organic silicon compounds suitable for use as the electron donor compound (α) include without limitation the following: diisopropyldimethoxysilane, diisobutyldimethoxysilane, di-t-butyldimethoxysilane, t-butylmethyldimethoxysilane, isobutylisopropyldimethoxysilane, t-butylisopropyl-dimethoxysilane, dicyclopentyldimethoxysilane, cyclopentyl-isopropyldimethoxysilane, cyclopentylisobutyldimethoxysilane, cyclopentyl-t-butyldimethoxysilane, dicyclohexyldimethoxysilane, cyclohexylmethyldimethoxysilane, cyclohexylethyldimethoxysilane, cyclohexylisopropyldimethoxysilane, cyclohexylisobutyldimethoxysilane, cyclohexyl-t-butyldimethoxysilane, cyclohexylcyclopentyldimethoxysilane, cyclohexylphenyldimethoxysilane, diphenyldimethoxysilane, phenylmethyldimethoxysilane, phenylisopropyldimethoxysilane, phenylisobutyldimethoxysilane, phenyl-t-butyldimethoxysilane, phenylcyclopentyldimethoxysilane, diisopropyldiethoxysilane, diisobutyldiethoxysilane, di-t-butyldiethoxysilane, t-butylmethyldiethoxysilane, dicyclopentyldiethoxysilane, dicyclohexyldiethoxysilane, cyclohexylmethyldiethoxysilane, cyclohexylethyldiethoxysilane, diphenyldiethoxysilane, phenylmethyldiethoxysilane, 2-norbornanemethyldimethoxysilane, derivatives thereof, or combinations thereof.

In an embodiment, the electron donor component (C) comprises an electron donor compound (β) comprising organic silicon compounds represented by the following general formula:

R¹⁶R¹⁷Si(OR¹⁸)₂

wherein R¹⁶ represents a C₁ to C₂₀ hydrocarbon group. Alternatively R¹⁶ represents a straight chain alkyl group such as methyl, ethyl, propyl, butyl, pentyl, derivatives thereof, or combinations thereof. In an embodiment, R¹⁷ represents a C₁ to C₅ hydrocarbon group. Alternatively R¹⁷ represents a hydrocarbon group having one carbon atom. In an embodiment, R¹⁸ represents a C₁ to C₂₀ hydrocarbon group; alternatively a C₁ to C₅ hydrocarbon group. Specific examples of such organic silicon compounds which are suitable for use as the electron donor compound (β) include the following: dimethyldimethoxysilane, ethylmethyldimethoxysilane, propylmethyldimethoxysilane, butylmethyldimethoxysilane, pentylmethyldimethoxysilane, hexylmethyldimethoxysilane, heptylmethyldimethoxysilane, octylmethyldimethoxysilane, dodecylmethyldimethoxysilane, derivatives thereof, or combinations thereof. The catalyst comprising the solid catalyst component (A), the organoaluminum compound (B), and the electron donor component (C) may be prepared as described in U.S. Pat. Nos. 6,337,377, and 6,127,303, each of which is incorporated by reference herein in its entirety.

Polymerization reactions using the dual external donor catalyst may be carried out in any manner known in the art. Suitable polymerization processes include, but are not limited to, slurry polymerizations, gas phase polymerizations, solution polymerizations, and multi-reactor combinations thereof. Thus, any polymerization zone known in the art to produce polymeric compositions of the type disclosed herein can be utilized. For example, a stirred reactor may be utilized for a batch process, or a loop reactor or a continuous stirred reactor may be used for a continuous process.

A typical polymerization method is a slurry polymerization process (also known as the particle form process), which is well known in the art and is disclosed, for example, in U.S. Pat. No. 3,248,179, incorporated by reference herein in its entirety. Other polymerization methods suitable for use in the current disclosure include slurry processes such as those employing a loop reactor of the type disclosed in U.S. Pat. No. 6,239,235, incorporated by reference herein in its entirety, and those utilized in a plurality of stirred reactors either in series, parallel, or combinations thereof, where the reaction conditions are different in the different reactors. Suitable diluents used in slurry polymerization are well known in the art and include hydrocarbons that are liquids under reaction conditions. The term “diluent” as used in this disclosure does not necessarily mean an inert material, as this term is meant to include compounds and compositions that may contribute to polymerization process. Examples of hydrocarbons that may be used as diluents include, but are not limited to, cyclohexane, isobutane, n-butane, propane, n-pentane, isopentane, neopentane, and n-hexane. Typically, isobutane may be used as the diluent in a slurry polymerization, as provided by U.S. Pat. Nos. 4,424,341, 4,501,885, 4,613,484, 4,737,280, and 5,597,892, each of which is incorporated by reference herein in its entirety. In an embodiment, the EP-RCPs of this disclosure are prepared by the polymerization of propylene carried out under bulk conditions. In such embodiments, the monomer is the reactant and also serves as the diluent. Monomer conversion in a loop slurry process can be as high as 70%.

Various polymerization reactors are contemplated by the present disclosure. As used herein, “polymerization reactor” includes any polymerization reactor or polymerization reactor system capable of polymerizing olefin monomers to produce copolymers of the present invention. Such reactors may be slurry reactors, gas-phase reactors, solution reactors, or any combination thereof. Gas phase reactors may comprise fluidized bed reactors or tubular reactors. Slurry reactors may comprise vertical loops or horizontal loops. Solution reactors may comprise stirred tank or autoclave reactors.

Polymerization reactors suitable for the present disclosure may comprise at least one raw material feed system, at least one feed system for catalyst or catalyst components, at least one reactor system, at least one polymer recovery system or any suitable combination thereof. Suitable reactors for the present disclosure further may comprise any one, or combination of, a catalyst storage system, an extrusion system, a cooling system, a diluent or monomer recycling system, and a control system. Such reactors may comprise continuous take-off and recycling of, diluent or unreacted monomer. Generally, continuous processes may comprise the continuous introduction of a monomer, a catalyst, and a diluent into a polymerization reactor and the continuous removal from this reactor of a suspension comprising polymer particles and the diluent.

Polymerization reactor systems of the present invention may comprise one type of reactor per system or multiple reactor systems comprising two or more types of reactors operated in parallel or in series. Multiple reactor systems may comprise reactors connected together to perform polymerization or reactors that are not connected. The polymer may be polymerized in one reactor under one set of conditions, and then transferred to a second reactor for polymerization under a different set of conditions.

According to one aspect of the disclosure, the polymerization reactor system may comprise at least one loop slurry reactor. Such reactors are known in the art and may comprise vertical or horizontal loops. Such loops may comprise a single loop or a series of loops. Multiple loop reactors may comprise both vertical and horizontal loops. The slurry polymerization is typically performed in an organic solvent that can disperse the catalyst and polymer. Examples of suitable solvents include butane, hexane, cyclohexane, octane, and isobutane. Monomer, solvent, catalyst and any comonomer may be continuously fed to a loop reactor where polymerization occurs. Polymerization may occur at low temperatures and pressures. Reactor effluent may be flashed to remove the solid resin.

According to a further aspect of the disclosure, the polymerization reactor system may comprise the combination of two or more reactors. Production of polymers in multiple reactors may include several stages in at least two separate polymerization reactors interconnected by a transfer device making it possible to transfer the polymers resulting from the first polymerization reactor into the second reactor. The desired polymerization conditions in one of the reactors may be different from the operating conditions of the other reactors. Alternatively, polymerization in multiple reactors may include the manual transfer of polymer from one reactor to subsequent reactors for continued polymerization. Such reactors may include any combination including, but not limited to, multiple loop reactors, multiple gas reactors, a combination of loop and gas reactors, a combination of autoclave reactors or solution reactors with gas or loop reactors, multiple solution reactors, or multiple autoclave reactors.

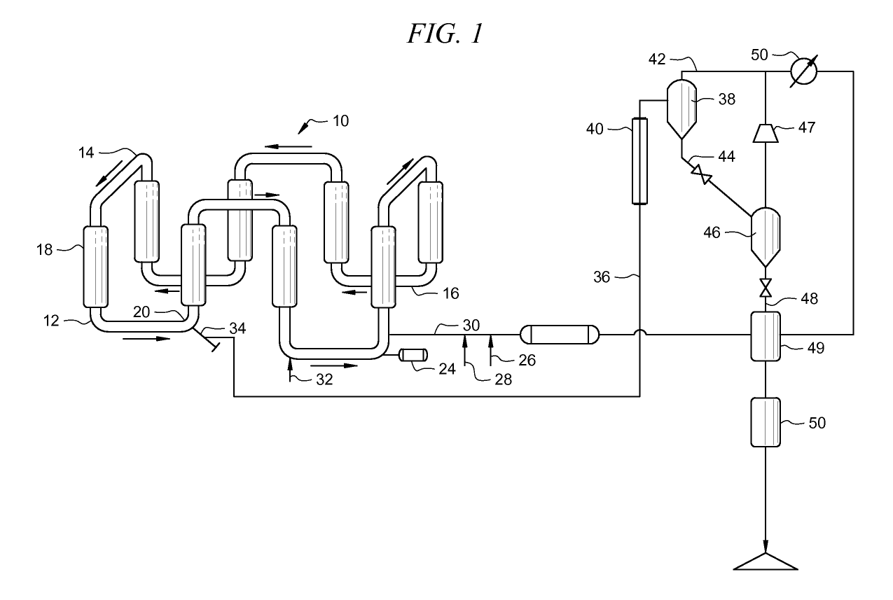

An embodiment of a reactor suitable for use in the preparation of the EP-RCPs of this disclosure is set forth in FIG. 1. Referring now to FIG. 1, a loop reactor 10 is shown having vertical segments 12, upper horizontal segments 14 and lower horizontal segments 16. These upper and lower horizontal segments define upper and lower zones of horizontal flow. In FIG. 1, the loop reactor has eight vertical segments, although it is contemplated that the present process may be used with a loop reactor having a higher or lower number of vertical segments. The reactor may be cooled by means of two pipe heat exchangers formed by a pipe and jacket. The reactor is typically a pipe loop reactor with an inner diameter of from about 4 inches to about 48 inches.

Each segment or leg is connected to the next segment or leg by a smooth bend or elbow 20 thus providing a continuous flow path substantially free from internal obstructions. The fluid slurry is circulated by means of impeller (not shown) driven by a motor 24. Monomer, comonomer, if any, and make up diluent or monomer are introduced via lines 26 and 28 respectively which can enter the reactor directly at one or a plurality of locations or can combine with condensed diluent recycle line 30 as shown. Catalyst is introduced via catalyst introduction means 32, which provides a zone (location) for catalyst introduction. Withdrawn slurry may be passed via conduit 36 to a polymer recovery system that is known in the art. Withdrawn slurry is passed into high-pressure flash chamber 38. Prior to entering the chamber the withdrawn slurry may be heated by flashline heater 40. Vaporized diluent exits the flash chamber via line 42 for further processing which includes condensation by simple heat exchange using recycle condenser 50, and return to the system, without the necessity for compression, via recycle diluent line 30. Polymer particles are withdrawn from high-pressure flash chamber 38 via line 44 for further processing using techniques for preparing the polymer as finished product. Alternatively, they are passed to low-pressure flash chamber 46 and thereafter to a series of purge columns 49 and 50 via line 48 before further processing using techniques for preparing the polymer as finished product. Separated diluent passes through compressor 47 to line 42. Such reactors are described in detail U.S. Pat. Nos. 7,015,289 and 5,565,175, each of which is incorporated by reference herein in its entirety. Separation operations can include a high pressure flash, a low pressure flash, cyclonic separation, at least one purge column, a drier, or any combination.

### EXAMPLES

The invention having been generally described, the following examples are given as particular embodiments of the invention and to demonstrate the practice and advantages thereof. It is understood that the examples are given by way of illustration and are not intended to limit the specification of the claims in any manner.

### Example 1

Two samples of an EP-RCP polymer were prepared using a dual external donor catalyst of the type disclosed in U.S. Pat. No. 6,337,377 which was previously referenced herein. The EP-RCP samples were given the designations Sample A and Sample B. Preparation of the samples took place over a 2-day period on reactor system 2 (Rx 2). Rx 2 is of the type previously disclosed herein an illustrative embodiment of which is presented in FIG. 1. The run consisted of stepping ethylene concentration in 0.5% increments until a final concentration of 3.5% was met. An outline of a test run for the production of the EP-RCPs of this disclosure is as follows:
1. Make adjustments on the Rx to prepare for type change
   a. Lower temperature on Rx to 165 F
   b. Lower production to minimum rates (12,000 lbs/hr).
2. Feed Donor A at 0.29 ppm which is cyclohexy-ethyl-dimethoxy-silane. Add Donor B at 5.6 ppm which is n-propyl-methyl-dimethoxy-silane.
3. Adjust hydrogen to proper melt flow (2.0 MF).
4. Ensure the absence of fluff in the flash tank
5. Follow normal ethylene addition procedure to initially target 1.0% ethylene.
6. One hour after ethylene addition, begin hourly fluff sampling for ethylene and xylenes.
7. Delay time on Rx will vary, but residence times should be around 5 hours. Wait at least 2 residence times (total of 10 hours) before making any changes.
8. Increase ethylene in 0.5% increments (about 10 hours per change).
9. Once material is on spec (or within acceptable parameters), produce 1 hopper car each Sample A and Sample B.

The run timeline is summarized as follows:

Day 1
Rx Change—Spiked Donor B at 02:25 where Donor B chemical name is “n-propyl-methyl-dimethoxy-silane”
Rx Change—Temp at 165 F at 03:25
Rx Change—Added Hydrogen at 04:30 (0.30 SCFH/GPM)
Rx Change—Added Ethylene at 07:30 (1%, 5.1 PPH/Delta)
Hourly Ethylene Sampling at 12:00
Rx Change—Increased Ethylene at 13:30 (1.5%, 8.2 PPH/Delta)
Rx Change—Increased Hydrogen at 14:00 (0.35 SCFH/GPM)
Rx Change—Increased Ethylene at 23:00 (2% 11.3 PPH/Delta)

Day 2
Rx Change—Lower Hydrogen at 0900 (0.30 SCFH/GPM)
Rx Change—Increased Ethylene at 0900 (2.5%, 15.0 PPH/Delta)
Reduced sampling to bi-hourly until delay time is up (˜4 pm)
Rx Change—Increased Ethylene at 15:00 (3.0%, 17 PPH/Delta)
Rx Change—Decreased solids concentration due to increasing circulation pump amps (44.25) at 16:04 (61% to 59%)
Rx Change—Decreased solids concentration due to increasing circulation pump amps (45.47) at 16:42 (59% to 58%)
Rx Change—Decreased solids concentration due to high circulation pump amps (44.81) at 19:26 (58% to 56%)

Day 3
Rx Change—Increased Ethylene at 04:45 (3.5%, 20.5 PPH/Delta)
Circulation pump amps at 46 at 05:43
Rx Change—Decreased solids concentration due to increasing circulation pump amps (46.28) at 05:52 (56% to 55%)
Circulation pump amps at 47 at 06:00
Circulation pump amps at 48 at 06:07
Rx Change—Began to decrease reactor production due to high circulation amps at 06:07 (13,380 lb/hr at 06:07)
Circulation pump amps at 48.18 at 06:12
Rx Production at 11,200 lb/hr at 06:39
Circulation pump amps at 44.32 at 06:39
Circulation pump amps at 42.81 at 07:00
Run Complete at 17:25

Reactor variables were monitored at various process input tag points during the course of the reactor run. All test run objectives were met including a final ethylene concentration of 3.4% (measured by IR), and a final melt flow near 2.0. At the beginning and end of the trial there were increases in level in the flash tank. These increases occurred at ethylene concentrations of 1.5 and 3.0%, respectively. According to operations levels will build occasionally during copolymers runs.

Four samples of an EP-RCP were prepared in the same manner as described previously, except using a single external donor catalyst system where the donor is cyclohexylethyldimethoxysilane. Table 1 lists the polymer sample designations used throughout the remainder of the disclosure:

| Sample Designation | Description |
|---|---|
| A | EP-RCP of this disclosure prepared using a dual donor external |
| | catalyst where the donors are is cyclohexylethyldimethoxysilane |
| | and n-propyl-methyl-dimethoxy-silane |
| B | EP-RCP of this disclosure prepared using a dual donor external |
| | catalyst where the donors are cyclohexylethyldimethoxysilane and |
| | n-propyl-methyl-dimethoxy-silane |
| F | EP-RCP prepared using a single donor external catalyst system |
| | where the donor is cyclohexylethyldimethoxysilane |
| G | EP-RCP prepared using a single donor external catalyst system |
| | where the donor is cyclohexylethyldimethoxysilane |
| X | EP-RCP prepared using a single external donor catalyst system |
| | where the donor is cyclohexylethyldimethoxysilane. |
| Y | EP-RCP prepared using a single external donor catalyst system |
| | where the donor is cyclohexylethyldimethoxysilane. |

### Example 2

Analysis of the polymers produced in Example 1 was carried out. All of the resins compared are random ethylene-propylene copolymer compositions with similar ethylene content. The products obtained contain 2.3-2.5 wt. % ethylene.

A summary of the melt flow rate, ethylene content, cold xylene solubles, log A_{w}, and the amount of TREF eluting components in a specified temperature range are presented in Table 2.

TABLE 2

| | | | | | | Amount of TREF eluting component | | | |
|---|---|---|---|---|---|---|---|---|---|
| | | | | | | (wt. %) | | | |
| | Melt | | | | Log A_{w} | | From 88° C. | | |
| | Flow | C₂ | CXS | 2 * C₂ | of CXS < 3 | | up to 98° C. | 98° C. or | |
| Sample | (g/10 min.) | (wt. %) | (wt. %) | (wt. %) | (wt. %) | Up to 88° C. | (A) | higher (B) | A/B |
| A | 2.3 | 2.3 | 6.1 | 4.6 | 23.0 | 22.7 | 16.0 | 61.3 | 3.8 |
| B | 2.4 | 2.5 | 6.8 | 5.0 | 24.8 | 26.2 | 19.6 | 54.2 | 2.8 |
| F | 2.3 | 2.8 | 5.1 | 5.6 | 33.2 | 18.8 | 21.7 | 59.5 | 2.7 |
| G | 2.0 | 3.3 | 5.6 | 6.6 | 31.3 | 22.2 | 29.9 | 47.9 | 1.6 |
| X | 2.2 | 3.5 | 5.7 | 7.0 | 31.2 | 26.2 | 19.6 | 54.2 | 2.8 |
| Y | 2.2 | 2.8 | 5.0 | 5.6 | 34.3 | 18.8 | 21.1 | 60.0 | 2.8 |

The results demonstrate that the EP-RCPs of this disclosure have cold xylene solubles weight percent greater than twice the magnitude of the ethylene content. Further, the log A_{w} less than 3 of CXS fractions of Samples A and B are less than 30 wt. % indicating the presence of an increased amount of high molecular weight materials when compared to the other polymer compositions evaluated

The presence of an increased amount of high molecular weight components in the EP-RCPs of this disclosure is further evinced by TREF analysis of the elution ratio. The amount of TREF eluting component at various temperatures was determined for the EP-RCPs of this disclosure using an automatic TREF apparatus, CFC T-150A manufactured by Dia Instrument Co., measurements were taken under the following conditions.

| Parameter | Comment |
|---|---|
| Solvent | Ortho-dichlorobenzene (including 0.01 wt. % |
| | 2,6-di-t-butyl-4-methylphenol (BHT) as a stabilizer) |
| | → Use of solution of sample and carrier |
| | in CFC apparatus |
| Sample | 25 mg sample/100 ml Ortho-dichlorobenzene |
| concentration | (including 0.01 wt. % BHT) |
| Injection amount of | 0.8 ml |
| solution into CFC | |
| TREF column | within ±0.2° C. |
| temperature | |
| distribution | |
| Solvent flow | 1.0 ml/min |
| GPC column | Shodex UT-806M × 2 |
| Detector | IR |
| Measured wave | 3.41 μm |
| number: | |

The sample solution was introduced at 140° C. into the column, gradually cooled down to 0° C. at a rate of 1° C. per hour so that the sample polymer was adsorbed on the surfaces of the filler. Then, the column temperature was raised under above-mentioned conditions and, at the same time, the solvent was permitted to start flowing. The concentration of the polymer eluted at each of the temperature was measured by the infrared-ray detector to obtain a curve of elution temperature vs. elution amount.

These values are presented in Table 5.

TABLE 5

| Elution Temp | | | | | |
|---|---|---|---|---|---|
| (° C.) | Fraction | Sample F | Sample G | Sample A | Sample B |
| ≦20 | 1 | 4.3 | 4.3 | 4.9 | 5.8 |
| >20, ≦75 | 2 | 8.7 | 10.2 | 11.5 | 13.1 |
| >75, ≦88 | 3 | 5.7 | 7.5 | 6.3 | 7.3 |
| >88, ≦98 | 4 | 21.7 | 29.9 | 16.0 | 19.6 |
| >98, ≦140 | 5 | 59.5 | 47.9 | 61.3 | 54.2 |
| | 5/4 | 2.7 | 1.5 | 3.6 | 2.8 |

### Example 3

Further analysis of the EP-RCPs of this disclosure (Samples A and B) was carried out to determine the Rockwell hardness, flexural modulus, notched Izod impact, haze, melt strength, bottle drop impact, seal initiation temperature and hot tack strength and these values are compared to those obtained for Sample F and presented in Table 7.

TABLE 7

| | | | | |
|---|---|---|---|---|
| ASTM | | | | |
| method | Units | Sample A | Sample B | Sample F |

Physical Properties

| | | | | | |
|---|---|---|---|---|---|
| Rockwell | D785 | R-scale | 85.0 | 83.0 | 93.7 |
| Hardness | | | | | |
| Flexural Modulus | D790 | Psi | 158,800 | 153,000 | 169,200 |
| Notched | D256 | Ft. lb/in | 6.7 | 7.3 | 5.0 |
| Izod @ 23° C. | | | | | |
| Haze | D1003 | % | 9.3 | 9.4 | 10.5 |
| Melt Strength | | Seconds | 10.1 | 8.6 | 7.2 |

Bottle Properties

| | | | | | |
|---|---|---|---|---|---|
| Bottle Drop | D2643 | Feet | 7.8 | 10.3 | 3.2 |
| Impact | | | | | |
| Average Bottle | | In/1000 | +/−1.99 | | +/−2.93 |
| Wall Thickness | | | | | |

The results demonstrate the EP-RCPs of this disclosure have an increased softness reflected in a lower Rockwell hardness and flexural modulus when compared to a EP-RCP prepared using a single external donor catalyst. Further, Samples A and B display improved impact properties, specifically an increased notched Izod impact strength, and improved optical properties, specifically a reduced haze when compared to EP-RCPs prepared using a single external donor catalyst, Sample F. Bottle specimens prepared using Samples A and B also displayed an improved bottle drop impact strength.

The results also demonstrate the EP-RCPs of this disclosure have an improved uniformity of bottle wall thickness in injection stretch blow molded bottles when compared to a EP-RCP prepared using a single external donor catalyst. Sample A exhibits a wall thickness uniformity improvement of about 32% when compared to EP-RCPs prepared using a single external donor catalyst, Sample F. The injection stretch blow molding process consists of reheating the preforms in a series of ovens powered by quartz lamps. Once the preform has reached a consistent temperature throughout its thickness it is positioned in a bottle mold where high-pressure air is blown into the preform, causing it to deform and conform to the shape of the bottle mold. The preforms for the injection stretch blow molded bottles feature a 38 mm thread with an inside diameter of 1.24 inches and an outside diameter of 1.33 inches. The preform height from the bottom of the support ledge to finish tip is 0.83 inches. The wall thickness of the body of the preform is 0.11 inches. The preform is 4.02 inches tall with the straight portion of the body being 1.18 inches in diameter. The bottles weigh 20.7 grams without finish. The bottle has an approximate volume of 355 ml. The finished bottle is 2.56 inches in diameter and 6.18 inches tall, with a nominal wall thickness of about 0.015 inches.

### Example 4

The thermal properties of a film prepared using the EP-RCPs of this disclosure were evaluated. Specifically, cast film was prepared using a one and one half inch extruder to reach a melt temperature of approximately 215° C. prior to sending the molten copolymer to a 12 inch vertical coat hanger cast film die with a 20 mil die opening. An air gap of one inch was allowed between the die lip and the casting roll. The copolymer passed from the die onto the hardened chrome casting roll held at 75° C. The process was controlled with a 20:1 draw ratio to produce 1 mil cast film. The seal initiation temperature and hot tack strength of film specimens of Sample A, and Sample F which is a random copolymer prepared using a single external donor catalyst were determined and those values are presented in Table 8.

TABLE 8

| Film Properties | ASTM method | Units | Sample A | Sample F |
|---|---|---|---|---|
| Seal Initiation | F2029 | ° C. | 125.6 | 129.0 |
| Temperature | | | | |
| Hot Tack @ 135° C. | F1921 | lbs | 0.50 | 0.35 |

The results demonstrate the EP-RCPs of this disclosure have a reduced seal initiation temperature. The lower seal initiation temperature may provide improved cycle time and result in a reduced energy requirement for manufacturing processes utilizing these polymers. Additionally, a hot tack improvement of 30% was noted at 500 milliseconds at 135° C. The greater hot tack strength allows faster cycles on form, fill, and seal equipment where filling occurs immediately following packaging fabrication. The hot tack strength may vary with time and cooling. For the purposes of this experiment, the hot tack measured the strength of the hot seal for a period of 500 to 1000 milliseconds following the opening of the sealing die away from the film.

Without further elaboration, it is believed that one skilled in the art can, using the description herein, utilize the present invention to its fullest extent. While preferred inventive aspects have been shown and described, modifications thereof can be made by one skilled in the art without departing from the spirit and teachings of the invention. The embodiments and examples described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The disclosures of all patents, patent applications, and publications cited herein are hereby incorporated by reference, to the extent that they provide exemplary, procedural or other details supplementary to those set forth herein.

What is claimed is:

1. An ethylene-propylene copolymer having a cold xylene solubles weight percent greater than twice the magnitude of the ethylene content wherein the ethylene content is measured by C13-NMR and having less than about 30% of the cold xylene solubles fraction having a log weight average chain length of less than about 1000 wherein the weight average chain length is measured by gel permeation chromatography.

2. The copolymer of claim 1 having an elution ratio of a fractionation component in the temperature range of from about 98° C. to about 140° C. to a fractionation component in the temperature range of from about 88° C. to about 98° C. of greater than about 2.5:1 as determined by temperature rising elution fractionation.

3. The copolymer of claim 1 having an ethylene content of from about 0.10 wt. % to about 8 wt. %.

4. The copolymer of claim 1 having a melt flow rate of from about 0.1 g/10 min to about 200 g/10 min.

5. The copolymer of claim 1 having a percentage of cold xylenes solubles of greater than about 0.2 wt. %.

6. The copolymer of claim 1 having a melting temperature of from about 100° C. to about 175° C.

7. The copolymer of claim 1 having a flexural modulus of from about 15 kpsi to about 300 kpsi.

8. The copolymer of claim 1 having a Rockwell hardness R-scale of equal to or less than about 100.

9. The copolymer of claim 1 having a notched Izod impact strength of greater than about 0.5 ft.*lb_{f}/in.

10. The copolymer of claim 1 having a Notched Izod impact strength of equal to or less than No Break.

11. An article fabricated from the copolymer of claim 1.

12. The article of claim 11 having a haze of less than about 35%.

13. The article of claim 12 having a clarity of from about 85% to about 99%.

14. The article of claim 12 having a seal initiation temperature of less than about 155° C.

15. The article of claim 12 having a hot tack opening force of greater than 0.1 lb.

16. The article of claim 12 is an injection stretch blowmolded bottle.

17. The article of claim 16 having a positive or negative variation in wall thickness of equal to or less than about 0.002 inches.

18. A method of producing a copolymer comprising:
contacting comonomers with a catalyst system in a reaction zone under conditions suitable for the formation of a copolymer wherein the catalyst system comprises at least two external donors and wherein the copolymer has a cold xylene solubles weight percent greater than twice the magnitude of the ethylene content wherein the ethylene content is measure by C13-NMR and having less than about 30% of the cold xylene solubles fraction having a log weight average chain length of less than about 1000 wherein the weight average chain length is measured by gel permeation chromatography.

19. The method of claim 18 wherein the copolymer comprises ethylene and propylene.

20. The method of claim 18 wherein the copolymer has a decreased Rockwell hardness when compared to an otherwise similar copolymer produced in the absence of a catalyst having at least two external donors.

21. The method of claim 18 wherein the copolymer has an increased processability when compared to an otherwise similar copolymer produced in the absence of a catalyst having at least two external donors.

22. The method of claim 18 wherein the increased processability comprises reduced knifewear, decreased stringing, improved extruder output, or combinations thereof.

23. The method of claim 18 wherein the at least two external donors include electron donative compound (α) and electron donative compound (β), provided that the pentad stereoirregularity index (mmr/mmmm) of a 105° C. xylene-insoluble fraction of a homopolypropylene obtained by carrying out polymerization by the use of electron donative compound (α) together with the above-mentioned solid catalyst component (A) and organoaluminum compound (B) satisfies the following condition:
0≦mmrr/mmmm≦0.0068; and
the pentad stereoirregularity index (mmrr/mmmm) of a 105° C. xylene-insoluble fraction of a homopolypropylene obtained by carrying out polymerization by the use of electron donative compound (β) together with the above-mentioned solid catalyst component (A) and organoaluminum compound (B) satisfies the following condition:
0.0068≦mmrr/mmmm≦0.00320.

24. An ethylene-propylene copolymer having less than about 30% of the cold xylene solubles fraction having a weight average chain length of less than about 1000 wherein the weight average chain length is measured by gel permeation chromatography and having an elution ratio of a fractionation component in the temperature range of from about 88° C. to about 140° C. to a fractionation component in the temperature range of from about 88° C. to about 98° C. of greater than about 2.5:1 as determined by temperature rising elution fractionation.
